(19) United States
(12) Patent Application Publication
(10) Pub. No.: US 2014/0280048 A1
(43) Pub. Date: Sep. 18, 2014

(54) NAVIGATING GRAPHICAL USER INTERFACES

(71) Applicant: APPLE INC., Cupertino, CA (US)

(72) Inventor: William M. Bumgarner, Cupertino, CA (US)

(73) Assignee: APPLE INC., Cupertino, CA (US)

(21) Appl. No.: 13/828,899

(22) Filed: Mar. 14, 2013

(51) Int. Cl. G06F 17/30

(52) U.S. Cl. CPC G06F 17/30554
USPC 707/722

(57) ABSTRACT

Incremental search and other human interactions with a graphical user interface of a media presentation system (e.g., a television system) are simplified using a keyboard (wireless or wired) and framework that allows a user to incrementally search for items in the GUI (e.g., icons) according to the location of the items in the GUI and a current selected item in the GUI. In some implementations, a delay is introduced after the first character is entered at the keyboard to prevent a selection indicator from bouncing around the GUI. In some implementations, weighted token matching and filtering are used in the incremental searching. In some implementations, the incremental search session is automatically reset if the user does not type for a period of time.

### TECHNICAL FIELD

This disclosure relates generally to applications for assisting users to navigate a graphical user interface (GUI) using a hardware keyboard.

### BACKGROUND

A digital media receiver (DMR) is a home entertainment device that may connect to a home network to retrieve digital media files (e.g., music, pictures, videos) from a personal computer or other networked media server and play them back on a home theater system or television. Users may access content stores directly through the DMR to rent movies and TV shows and stream audio and video podcasts. A DMR allows a user to sync or stream photos, music and videos from a personal computer and maintain a central home media library.

Some DMRs provide one or more GUIs that may be navigated by a user with a remote control device. Remote control devices, however, make tasks like navigating GUIs and text entry difficult for the user.

### SUMMARY

Incremental search and other human interactions with a graphical user interface of a media presentation system (e.g., a television system) are simplified using a keyboard (wireless or wired) and framework that allows a user to incrementally search for items in the GUI (e.g., icons) according to the location of the items in the GUI and a current selected item in the GUI. In some implementations, a delay is introduced after the first character is entered at the keyboard to prevent a selection indicator from bouncing around the GUI. In some implementations, weighted token matching and filtering are used in the incremental searching. In some implementations, the incremental search session is automatically reset if the user does not type for a period of time. In some implementations, the space bar on the keyboard performs a dual function of play/pause for controlling a media presentation and providing a space character during the incremental search sessions to allow the matching of phrases.

In some implementations, a method comprises: presenting items in a graphical user interface of a media presentation system; receiving a first character input from a keyboard; responsive to the first character input, searching the items presented in the graphical user interface according to the first character input, locations of items in the graphical user interface and a currently selected item in the graphical user interface; and selecting an item in the graphical user interface based on a result of the searching.

In some implementations, searching the items presented in the user interface further comprises waiting a predetermined amount of time after the first character input is received before searching. In some implementations, items are associated with weights based on a number of tokens matching one or more character inputs, and the weight is used in the searching to determine the item to be selected.

Particular implementations disclosed herein may be implemented to realize one or more of the following advantages. Incremental search of a GUI allows users to navigate quickly to items presented in the GUI in an intuitive manner by using a framework that supports context-based searching in a search space confined to a viewable area of the GUI. The framework allows the user to avoid entering large amounts of search text in search field, scrolling through long lists of sorted items or searching large databases of irrelevant data using a conventional query-based search engine.

The details of one or more implementations of assisted media presentation are set forth in the accompanying drawings and the description below. Other features, aspects, and advantages will become apparent from the description, the drawings, and the claims.

### BRIEF DESCRIPTION OF THE DRAWINGS

FIG. 1 is a block diagram of an exemplary system for keyboard navigation of GUIs.

FIG. 2 illustrates an exemplary GUI for keyboard navigation provided by the system of FIG. 1.

FIG. 3 illustrates another exemplary GUI for keyboard navigation provided by the system of FIG. 1.

FIG. 4 is a flow diagram of an exemplary process of keyboard navigation of GUIs.

FIG. 5 is a block diagram of an exemplary DMR for implementing keyboard navigation of GUIs.

### DETAILED DESCRIPTION

### Exemplary System

FIG. 1 is a block diagram of system 100 for keyboard navigation of GUIs. In some implementations, system 100 may include digital media receiver (DMR) 102, media presentation system 104 (e.g., a television) and hardware keyboard 112. DMR 102 may communicate with media presentation system 104 through a wired or wireless communication link 106. DMR 102 may also couple to a network 110, such as a wireless local area network (WLAN) or a wide area network (e.g., the Internet). Data processing apparatus 108 may communicate with DMR 102 through network 110. Data processing apparatus 108 may be a personal computer, a smart phone, an electronic tablet or any other data processing apparatus capable of wired or wireless communication with another device or system.

An example of system 100 may be a home network that includes a wireless router for allowing communication between data processing apparatus 108 and DMR 102. Other example configurations are also possible. For example, DMR 102 may be integrated in media presentation system 104 or within a television set-top box. In the example shown, DMR 102 is a home entertainment device that may connect to home network to retrieve digital media files (e.g., music, pictures, or video) from a personal computer or other networked media server and play the media files back on a home theater system or TV. DMR 102 may connect to the home network using either a wireless (IEEE 802.11x) or wired (e.g., Ethernet) connection. DMR 102 may cause display of GUIs that allow users to navigate through a digital media library, search for, and play media files (e.g., movies, TV shows, music and podcasts).

Keyboard 112 may communicate with DMR 102 through a wireless (e.g., radio frequency, infrared) or wired communication link. As described in reference to FIGS. 2-3, keyboard 112 may be used to navigate GUIs. Keyboard 112 may be Bluetooth™ wireless keyboard. Media presentation system 104 may be any display system capable of displaying digital media, including but not limited to a high-definition television, a flat panel display, a computer monitor, a projection device, etc.

### Exemplary Graphical User Interfaces

FIG. 2 illustrates an exemplary GUI 200 for keyboard navigation provided by the system of FIG. 1. In the example shown, GUI 200 is for navigating content for display on a media presentation system 104 (e.g., a television system). Users may navigate to items by typing on their keyboard. For example, a user may navigate to an icon using arrow keys and exit the user interface using an escape key. A selection indicator is used to provide visual feedback to the user when an item is selected. In FIG. 2, icon 202 is selected with selection indicator 204 (e.g., highlighted border) to indicate its selection by the user. Once selected, the user may press the enter key or other suitable key to open another GUI for Movies, as shown in FIG. 3.

The user may also use keyboard 112 to perform an incremental search for items that are at least partially viewable in GUI 200. For example, as the user types text at keyboard 112 one or more possible item matches for the text are found and selection indicator 204 highlights the matched item in the GUI. This immediate feedback allows the user to avoid typing an entire word or phrase. The method of incremental search may be distinguished from GUIs that use a dialog box to enter search queries.

In some implementations, incremental search for matching items is performed after the user has made a second character input. For example, the user may navigate from “Movies” icon 202 to “Settings” icon 206 by typing the letter “s” followed by the letter “e.” Immediately after the “e” key is pressed selection indicator 204 moves to “Settings” icon 206 (not shown). If there exists another icon in GUI 200 that has a label with the characters “se,” then the user would need to type immediately a third character “t” to move selection indicator 204 to “Settings” icon 206.

In some implementations, the incremental searching process described above utilizes a software framework that provides metadata about each item in GUI 200 through an Application Programming Interface (API). In some implementations, the framework may be implemented in software as part of an operating system installed on DMR 102. The software framework, allows for context-based, incremental search on items that are at least partially viewable in GUI 200. More particularly, the framework provides a set of rules for selecting among multiple items that match the characters input by the user during an incremental search session. As described below in reference to FIG. 3, the set of rules considers the locations of the items in GUI 200 and the currently selected item.

FIG. 3 illustrates another exemplary GUI 300 for keyboard navigation provided by the system of FIG. 1. The user has selected “Genres” element 302 to display movie titles organized in GUI 300 according to genre. In the example shown, there are three genres displayed in GUI 300: Family, Dramas and Horror. These example genres are used to illustrate the incremental search process.

As previously explained, a framework provides a set of rules that are used by an incremental search engine to determine which item to select. The incremental search is confined to the viewable area of GUI 300. Items will only be considered in the incremental search if the items are at least partially viewable in GUI 300. For clarity purposes, numerical designators are placed above some of the items in GUI 300 to indicate a sequence of events in an example incremental search session, and may not be part of GUI 300.

In the example session, the currently selected item is “Benji0” in the Family genre. The user presses the “d” key, and the selection indicator 304 (e.g., a highlighted border) is focused on the “Benji” icon for a predetermined period of time (e.g., ½ second) before moving to another icon. This delay avoids having selection indicator 304 bounce around GUI 300. The user immediately presses the “o” key to create the character sequence “do.” At this point in the example search session, there are six candidate icons in GUI 300 that have titles that contain the character sequence “do.” These icons include “The Shaggy Dog®,” “My Dog Skip®,” “Dog Day Afternoon®,” “Last of the Dog Men®,” “Day of the Dog®,” and “Dog Soldiers®.” The locations of these icons in GUI 300 span all three genres.

The incremental search process selects an item based on its location in GUI 300 relative to the currently selected item in GUI 300. For example, the icons “The Shaggy Dog” and “My Dog Skip” are located in the top row or “Family” genre, together with the icon for “Benji.” Note that the word “The” in “The Shaggy Dog” title is not used (it is filtered out) in the incremental search because it is considered a “noise” word. Other possible noise words include but not limited to “and,” “a” and “an.” If there are two noise words in a title such as “The The,” a search will be performed on the noise words. The weighted matching of “the” on “the the” is unique to that title because it is all noise words.

The incremental search engine searches icons that are within the same category as the currently selected icon before searching other categories (other rows) for matching icons. If no matching icons are found in the top row, the incremental search engine searches icons in the middle row in GUI 300 or the “Dramas” genre. If no icon matches are found in the “Dramas” genre, the incremental search engine searches icons in the bottom row or the “Horror” genre to find an icon match and so forth.

An application may have multiple GUIs each having items that are organized in a hierarchical search order. The search order is used to select between multiple matching candidates in a GUI. More particularly, the search order is determined according to rules that are based on context. The context includes the current GUI presented, the locations of items in the GUI and the currently selected item in the GUI.

Continuing with the current example, the user immediately types a “g” character. After the “g” character is types, we have the character sequence “dog” and the selection indicator moves to the icon “My Dog Skip,” as indicated by the numerical designation “2.” This icon is selected over the other five candidate icons that contain the word “dog” because it is located on the same row as the currently selected icon “Benji” and is closer to the currently selected icon than the icon “The Shaggy Dog.” Thus, the icon was selected by the incremental search engine based on the locations of the icons containing the word “dog” in GUI 300 and the currently selected icon “Benji” in GUI 300.

Continuing with the current example, the user immediately types a space character. When the user is engaged in an incremental search session, the space bar is used to play/pause media. When the user is engaged in an incremental search session as in this example, the space bar is used to enter a character to match phrases.

After the space character is typed, the selection indicator remains focused on the icon “My Dog Skip.” The character sequence “dog_” matches “My Dog Skip” and not “The Shaggy Dog.” There are also three other icons in GUI 300 that contain the character sequence “dog_.” These icons include “Dog Day Afternoon,” “Last of the Dog Men,” and “Dog Soldiers.” Because none of these icons is located in the top row, “My Dog Skip” remains the selected icon.

Continuing with this example, the user immediately types the character “d” to form the character sequence “dog_d.” In response to the “d” character being typed, the selection indicator moves to the “Dog Day Afternoon” icon. Since the sequence of characters did not match any titles in the first row, the search continues on the second row, where the character sequence was matched with the “Dog Day Afternoon” icon, as indicated by the numerical designation “3.” If no matching icons are found, the search continues on the bottom row and so forth.

If at any time during the session described above the user does not provide keyboard input for a predetermined period of time, the incremental search session is terminated and the next character entered will start a new incremental search session.

In some implementations, the incremental search session described above uses weighted token matching to select an item in GUI 300. In the example above, each icon is associated with a title, which is a collection of tokens, where a token is one or more characters or a word. Noise words like “the” may not be used in the matching process. Each time a new character is typed a new weight is generated for each item in GUI 300 based on the number of matching tokens and stored in a data structure that may be accessed by the incremental search engine or by other applications, such as text-to-speech engine for use in accessibility applications. The weight may be an integer value. Each character that is matched adds a numerical value (e.g., 5) to the total weight for the item. The more matching tokens the higher the weight. In the example above, after the user types “dog_,” the weight for “My Dog Skip” may be 20 and the weight for “The Shaggy Dog” may be 15. Since “My Dog Skip” has a higher weight, it would be selected over “The Shaggy Dog.”

In some implementations, titles, labels or other text associated with an item in GUI 300 may be stored in multiple languages to facilitate searching using multiple languages.

In some implementations if the number of items in the GUI exceeds a threshold number, data associated with items that are not in the GUI may be used in the searching. For example, selecting an item in the GUI may result in a long list of items being displayed in the GUI. The user may then move into the list using a designated key (e.g., Tab key) and begin searching the list using incremental searching.

In some implementations, the GUI being searched is automatically updated to remove items not in the incremental search results. Referring to the previous example, after the user types “do,” all icons are removed from GUI 300 except icons for “The Shaggy Dog,” “My Dog Skip,” “Dog Day Afternoon,” “Last of the Dog Men,” “Day of the Dog,” and “Dog Soldiers.” After the user types “dog,” all icons are removed from GUI 300 except the icon for “My Dog Skip.” After the user types “dog_” the icon for “My Dog Skip,” remains the only icon displayed in GUI 300. After the user types “dog_d,” GUI 300 is updated to show only the icon for “Dog Day Afternoon.”

### Exemplary Processes

FIG. 4 is a flow diagram of an exemplary process 400 of keyboard navigation of GUIs. All or part of process 400 may be implemented in, for example, DMR 500 as described in reference to FIG. 5. Process 400 may be one or more processing threads run on one or more processors or processing cores. Portions of process 400 may be performed on more than one device.

In some implementations, process 400 may begin by presenting items in a GUI of a media presentation system (402). The media presentation system may be a television system, a computer or any other data processing apparatus that is capable of presenting a GUI. The GUI may be generated by the media presentation system or by a DMR, set-top box or other appliance coupled to or embedded in the media presentation system.

Process 400 may continue by receiving a first character input from a keyboard wired or wirelessly coupled to the media presentation system (404). For example, the keyboard may be a wireless keyboard that communicates through a radio frequency link (e.g., a Bluetooth enabled keyboard).

Process 400 may continue by performing an incremental search for items in the GUI according to the character inputs and rules that determine search order in the GUI. The rules may be based on the locations of the items in the GUI and the currently selected item in the GUI (406). For example, items may be searched in a row of items in the GUI containing the currently selected item before other rows in the GUI are searched. Subsequent searching of rows may be based on a search order hierarchy, such as always searching rows from the top of the GUI to the bottom of the GUI. Other search order hierarchies are possible and depend on the structure of the GUI.

Process 400 may continue by selecting an item in the GUI based on a result of the search (408). Items may be any graphical object or user interface element that may be displayed in a GUI, such as an icon, thumbnail image or graphical object. The searching is incremental searching where the search is started after the second character is input. The searching is confined to items that are at least partially viewable in the GUI. The search order is based on rules according to locations of items in the GUI and the currently selected item.

In some implementations, each item is associated with tokens. Tokens may be characters or words in a title or label describing media content (e.g., cover art), and may be stored in multiple languages. Each time a character is entered at the keyboard, weights are calculated for each item in the GUI based on the number of tokens that match the character input. The item with the highest weight is the selected item. If two items have the same weight, one of the items is selected based on the location of the item relative the currently selected item, as described in reference to FIG. 3. If a predetermined period of time expires (e.g., 1 second) expires without the user providing keyboard input, the incremental search session is terminated and the next character entered by the user starts a new incremental search session.

### Example DMR Architecture

FIG. 5 is a block diagram of an exemplary DMR 500 for implementing keyboard navigation of GUIs. DMR 500 may generally include one or more processors or processor cores 502, one or more computer-readable mediums (e.g., non-volatile storage device 504, volatile memory 506), wired network interface 508, wireless network interface 510, input interface 512, output interface 514 and wireless keyboard interface 520. Each of these components may communicate with one or more other components over communication channel 518, which may be, for example, a computer system bus including a memory address bus, data bus, and control bus. DMR 500 may be a coupled to, or integrated with a media presentation system (e.g., a television), game console, computer, entertainment system, electronic tablet, set-top box, or any other device capable of receiving digital media.

In some implementations, processor(s) 502 may be configured to control the operation of DMR 500 by executing one or more instructions stored in computer-readable mediums 504, 506. For example, storage device 504 may be configured to store media content (e.g., movies, music), metadata (e.g., context information, content information), configuration data, user preferences, and operating system instructions. Storage device 504 may be any type of non-volatile storage, including a hard disk device or a solid-state drive. Storage device 504 may also store program code for one or more applications configured to present media content on a media presentation device (e.g., a television). Examples of programs include, a video player, a presentation application for presenting a slide show (e.g. music and photographs), etc. Storage device 504 may also store program code for implementing an incremental search engine for performing incremental searching, as described in reference to FIGS. 1-4.

Wired network interface 508 (e.g., Ethernet port) and wireless network interface 510 (e.g., IEEE 802.11x compatible wireless transceiver) each may be configured to permit DMR 500 to transmit and receive information over a network, such as a local area network (LAN), wireless local area network (WLAN) or the Internet. Wireless network interface 510 may also be configured to permit direct peer-to-peer communication with other devices, such as an electronic tablet or other mobile device (e.g., a smart phone).

Input interface 512 may be configured to receive input from another device (e.g., a keyboard, game controller) through a direct-wired connection, such as a USB, eSATA or an IEEE 1394 connection.

Output interface 514 may be configured to couple DMR 500 to one or more external devices, including a television system, a monitor, an audio receiver, and one or more speakers. For example, output interface 514 may include one or more of an optical audio interface, an RCA connector interface, a component video interface, and a High-Definition Multimedia Interface (HDMI). Output interface 514 also may be configured to provide one signal, such as an audio stream, to a first device and another signal, such as a video stream, to a second device. Memory 506 may include non-volatile memory (e.g., ROM, flash) for storing configuration or settings data, operating system instructions, flags, counters, etc. In some implementations, memory 506 may include random access memory (RAM), which may be used to store media content received in DMR 500, such as during playback or pause. RAM may also store content information (e.g., metadata) and context information.

DMR 500 may include wireless keyboard interface 520 that may be configured to receive commands from one or more wireless keyboard devices (e.g., device 112). Wireless keyboard interface 520 may receive the commands through a wireless connection, such as infrared or radio frequency signals (e.g., Bluetooth enabled keyboard). The received commands may be utilized, such as by processor(s) 502, to control media playback or to configure receiver 500. In some implementations, DMR 500 may be configured to receive commands from a user through a touch screen interface. DRM 500 also may be configured to receive commands through one or more other input devices, including a keyboard, a keypad, a touch pad, a voice command system, and a mouse coupled to one or more ports of input interface 512.

The features described may be implemented in digital electronic circuitry, in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output. Alternatively or in addition, the program instructions may be encoded on a propagated signal that is an artificially generated signal, e.g., a machine-generated electrical, optical, or electromagnetic signal that is generated to encode information for transmission to suitable receiver apparatus for execution by a programmable processor.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. A computer may also include or be operatively coupled to communicate with one or more mass storage devices for storing data files. Such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server or that includes a middleware component, such as an application server or an Internet server, or that includes a front-end component, such as a client computer having a GUI or an Internet browser, or any combination of them. The components of the system may be connected by any form or medium of digital data communication such as a communication network. Some examples of communication networks include LANs, WANs, and other computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. In addition, other steps may be provided, or steps may be eliminated, from the described flows, and other components may be added to, or removed from, the described systems. Accordingly, other implementations are within the scope of the following claims.

What is claimed is:

1. A method comprising:
presenting items in a graphical user interface of a media presentation system;
receiving a first character input from a keyboard coupled to the media presentation system;
responsive to the first character input, searching the items presented in the graphical user interface according to the first character input, locations of items in the graphical user interface and a currently selected item in the graphical user interface; and
selecting an item in the graphical user interface based on a result of the searching,
where the method is performed by one or more hardware processors.

2. The method of claim 1, where searching the items presented in the user interface, further comprises:
waiting a predetermined amount of time after the first character input is received before searching.

3. The method of claim 1, where the items are associated with weights based on a number of tokens matching character inputs, and the weight is used in the searching to determine the item to be selected.

4. The method of claim 3, where the tokens are words and searching the items includes filtering out noise words before matching the character inputs with words associated with items.

5. The method of claim 4, further comprising:
pre-computing the weights and storing the weights and tokens in a data structure to be accessed during the searching.

6. The method of claim 1, further comprising:
determining that no character input is received for a predetermined period of time; and
terminating the searching.

7. The method of claim 1, further comprising:
determining that the number of items in the graphical user interface exceeds a threshold number; and
searching data associated with items that are not presented in the graphical user interface.

8. The method of claim 1, where searching the items presented in the graphical user interface according to the first character input, further comprises:
automatically updating the graphical user interface to remove items not in the search results.

9. The method of claim 1, where the first character input is a space character, the method further comprising:
receiving a second space character input from the keyboard; and
playing or pausing content in the media presentation system.

10. The method of claim 1, further comprising:
responsive to selecting an item in the graphical user interface, presenting a list of items related to the selected item in the graphical user interface;
receiving a second character input; and
searching the list of items according to the second character input.

11. A system comprising:
one or more processors;
memory coupled to the one or more processors and storing instructions, which, when executed by the one or more processors, causes the one or more processors to perform operations comprising:
presenting items in a graphical user interface of a media presentation system;
receiving a first character input from a keyboard coupled to the media presentation system;
responsive to the first character input, searching the items presented in the graphical user interface according to the first character input, locations of items in the graphical user interface and a currently selected item in the graphical user interface; and
selecting an item in the graphical user interface based on a result of the searching.

12. The system of claim 11, where searching the items presented in the user interface, further comprises:
waiting a predetermined amount of time after the first character input is received before searching.

13. The system of claim 11, where the items are associated with weights based on a number of tokens matching character inputs, and the weight is used in the searching to determine the item to be selected.

14. The system of claim 13, where the tokens are words and searching the items includes filtering out noise words before matching the character inputs with words associated with items.

15. The system of claim 14, further comprising:
pre-computing the weights and storing the weights and tokens in a data structure to be accessed during the searching.

16. The system of claim 11, further comprising:
determining that no character input is received for a predetermined period of time; and
terminating the searching.

17. The system of claim 11, further comprising:
determining that the number of items in the graphical user interface exceeds a threshold number; and
searching data associated with items not presented in the graphical user interface.

18. The system of claim 11, where searching the items presented in the graphical user interface according to the first character input, further comprises:
automatically updating the graphical user interface to remove items not in the search results.

19. The system of claim 11, where the first character input is a space character input, the method further comprising:
receiving a second space character input from the keyboard; and
playing or pausing content in the media presentation system.

20. The system of claim 11, further comprising:
responsive to selecting an item in the graphical user interface, presenting a list of items related to the selected item in the graphical user interface;
receiving a second character input; and
searching the list of items according to the second character input.
